(19) United States
(12) Patent Application Publication
(10) Pub. No.: US 2006/0095861 A1
(43) Pub. Date: May 4, 2006

(54) Information processing apparatus and recording medium having program recorded therein

(75) Inventor: Yukiko Shikata, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/261,711

(22) Filed: Oct. 31, 2005

(30) Foreign Application Priority Data
Nov. 2, 2004 (JP) 2004-319608

(51) Int. Cl. G06F 17/00

(52) U.S. Cl. 715/777

(57) ABSTRACT

An information processing apparatus which provides a graphical user interface via a display device includes: a dialog box display control unit which causes the display device to display a dialog box having plural tab pages; and a menu display control unit which causes the display device to display a menu for selecting items displayed as a list. The menu display control unit includes items indicating the plural tab pages in the list of the menu. The dialog box display control unit causes, when any one of the tab pages is selected in the menu, the display device to display a dialog box including the tab page in a state in which the selected tab page is displayed. Consequently, convenience of use of a graphical user interface which uses a dialog box having plural tab pages is improved.

### BACKGROUND OF THE INVENTION

The present invention relates to an information processing apparatus, and, in particular, to a graphical user interface provided by the information processing apparatus.

As described in Japanese Patent Laid-open Publication No. 2001-344051, in computer systems in recent years, processing for causing a user to set various kinds of information and displaying the various kinds of information is performed using a so-called dialog box with which the processing can be performed on an independent small screen interactively. At the time of the processing in the case in which there are many kinds of information, a dialog box, in which control for setting those pieces of information and areas for indicating the information are arranged to be distributed in plural tab pages, is used.

FIGS. 3, 4, and 5 are diagrams showing examples of a dialog box 500 having plural tab pages. In this example, the dialog box 500 includes an “action” tab page 500a (FIG. 3), a “expendables” tab page 500b (FIG. 4), and a “job information” tab page (FIG. 5).

A dialog box having plural tab pages is displayed according to prescribed operations, for example, selection from a menu or double click of an icon. In that case, a tab page to be displayed first is fixed.

In other words, in the dialog box having plural tab pages, a default display tab pages is set. In this example, when the dialog box 500 is opened, first, the “action” tab page 500a (FIG. 3), which is a first tab page, is displayed.

Therefore, even when a user wishes to display a tab page other than the default display tab page, the user needs to open the dialog box, in which the default tab page is displayed, once and designate a target tab anew. As such, satisfying level of utility was not attained.

### SUMMARY OF THE INVENTION

It is an object of the invention to improve convenience of use of a graphical user interface which uses a dialog box having plural tab pages.

An information processing apparatus, which is a first aspect of the invention for solving the problem described above, is an information processing apparatus which provides a graphical user interface via a display device, the information processing apparatus including:

dialog box display control means which causes the display device to display a dialog box having plural tab pages; and

menu display control means which causes the display device to display a menu for selecting items displayed as a list, wherein

the menu display control means includes items indicating the plural tab pages in the list of the menu, and

the dialog box display control means causes, when any one of the tab pages is selected in the menu, the display device to display a dialog box including the tab page in a state in which the tab page is displayed.

According to the invention, in the graphical user interface which uses a dialog box having plural tab pages, since a tab page can be directly displayed from the menu, it is possible to improve convenience of use of the graphical user interface.

The dialog box display control means can switch, when another tab page is designated in the dialog box in which the tab page selected in the menu is displayed, the display to the designated tab page to cause the display device to display the dialog box.

This makes it unnecessary to select a tab page from the menu again or close a displayed tab page in order to open another tab page included in the dialog box.

A recording medium having recorded therein a program, which is a second aspect of the invention for solving the problem, is a recording medium having recorded therein a program which is executed by an information processing apparatus including: dialog box display control means which causes a display device to display a dialog box having plural tab pages; and menu display control means which causes the display device to display a menu for selecting items displayed as a list, wherein

the program causes the information processing apparatus to perform processing for

causing the menu display control means to include a group of items indicating tab pages in a list of the menu, and

causing, when any one of the tab pages is selected in the menu, the dialog box display control means to cause the display device to display a dialog box including the tab page in a state in which the selected tab page is displayed.

### BRIEF DESCRIPTION OF THE DRAWINGS

FIG. 1 is a block diagram for explaining a hardware configuration of a printing system;

FIG. 2 is a block diagram showing a functional configuration of a computer;

FIG. 3 is a diagram showing an example of a dialog box having plural tab pages;

FIG. 4 is a diagram showing an example of the dialog box having plural tab pages;

FIG. 5 is a diagram showing an example of the dialog box having plural tab pages;

FIG. 6 is a diagram showing an icon corresponding to a status monitor section;

FIG. 7 is a flow diagram for explaining processing in the case in which an icon receives predetermined operation from a user; and

FIG. 8 is a diagram showing a menu to be displayed.

### DETAILED DESCRIPTION OF THE PREFERRED EMBODIMENTS

An embodiment of the invention will be explained with reference to the drawings. This embodiment will be explained with a case in which the invention is applied to a printer host constituting a printing system as an example. However, it is possible to apply the invention generally to display of a dialog box having plural tab pages in an information processing apparatus.

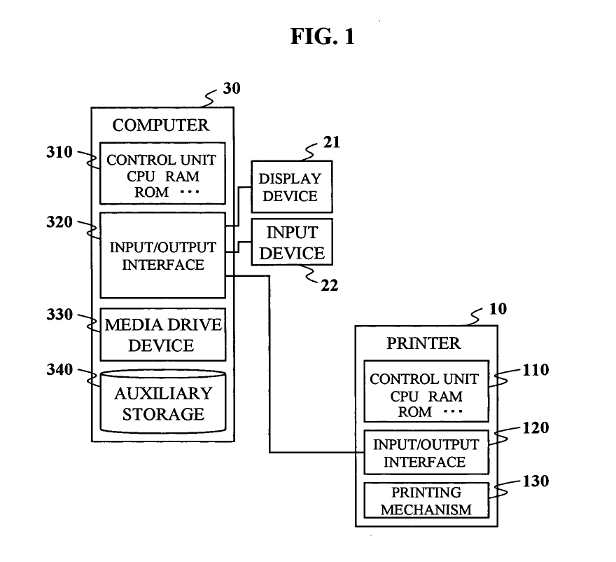

FIG. 1 is a block diagram for schematically explaining a hardware configuration of a printing system in this embodiment.

As shown in the figure, in the printing system, a computer 30 for realizing various kinds of processing by application software, print processing by a printer driver, a user interface via an input/output device, and the like is connected to a printer 10. A display device 21 such as a color display, an input device 22 such as a mouse and a keyboard, and the like are connected to a main body of the computer 30. Note that a constitution of the printing system is not limited to this.

In this embodiment, the computer 30 functions as a printer host which generates print data, transmits the print data to the printer 10, manages a state of the printer 10, and displays state information (status).

It is possible to use, for example, a general-purpose information processing apparatus such as a personal computer as the computer 30. In this embodiment, the computer 30 includes a control unit 310 including a Central Processing Unit (CPU) which executes various programs, a Random Access Memory (RAM) which temporarily stores data, programs, and the like, and a Read Only Memory (ROM) in which various data, various programs, and the like for controlling the computer 30 are stored in advance in a nonvolatile manner, an input/output interface 320 for connecting the computer 30 to the display device 21, the input device 22, the printer 10, and the like, a media drive device 330 for accessing a recording medium such as a CD-ROM, and an auxiliary storage 340 such as a hard disk. It goes without saying that a configuration of the computer 30 is not limited to this.

A printer driver program and a status monitor program, which are computer programs for causing the computer 30 to function as a printer host, are generally developed by a manufacturer of the printer 10 to correspond to a model of the printer 10. The printer driver program and the status monitor program are recorded in a recording medium such as a CD-ROM and distributed. Alternatively, the printer driver program and a status monitor program are circulated via a computer network such as the Internet. It is also possible to develop the status monitor program to be included in the printer driver program. These programs are installed in the computer 30 and executed to realize functions described later.

The printer 10 may be, for example, a page printer including a print mechanism of a laser system. The page printer of the laser system includes a toner cartridge which contains a toner in a housing. The page printer of the laser system performs printing by transferring the toner onto a print medium such as a print sheet. Note that the printer 10 may be a color laser printer or a monochrome laser printer. For example, a printer of an ink-jet system may be used instead of the printer of the laser system.

The printer 10 includes a control unit 110 which includes a CPU, a RAM, and a ROM and controls various kinds of processing in the printer 10, a network interface 120 for connecting the printer 10 to a computer network 60, and a printing mechanism 130 including print mechanisms such as a toner cartridge, a photosensitive drum, and a laser beam irradiating mechanism, and a sheet feeding and discharging mechanism. It goes without saying that a configuration of the printer 10 is not limited to this.

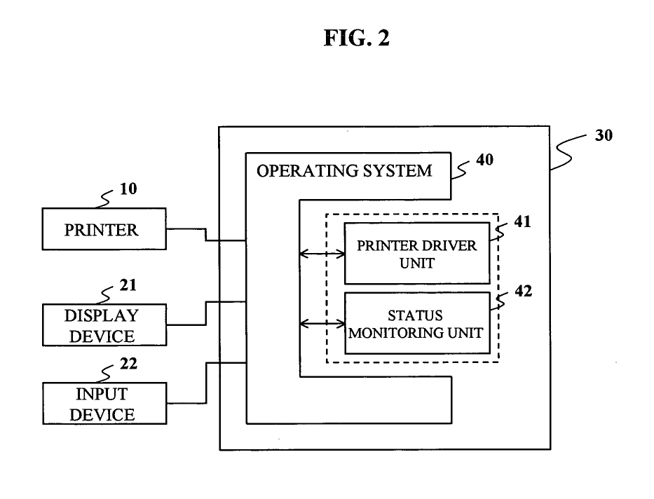

FIG. 2 is a block diagram showing a functional configuration of the computer 30 to which the invention is applied.

As shown in the figure, the computer 30 includes an operating system unit 40, a printer driver unit 41, and a status monitoring unit 42.

The printer driver unit 41 and the status monitoring unit 42 are established in a pair in the computer 30 to correspond to the printer 10 connected to the computer 30.

The operating system unit 40 is so-called basic software which controls a basic user interface, file management, and the like for the computer 30. The operating system unit 40 adopts a graphical user interface and provides a user interface which uses a dialog box or the like having plural tab pages.

The printer driver unit 41 and the status monitoring unit 42 are functional units which operate on the operating system unit 40. Therefore, when the status monitoring unit 42 displays a dialog box including plural tab pages, a menu, and the like, the status monitoring unit 42 outputs data of a format, which is set by the operating system unit 40, to the operating system unit 40. Consequently, display on the display device 21 is performed.

The printer driver unit 41 performs processing for causing the printer 10 to print a document created by not-shown application software.

The status monitoring unit 42 performs communication with the printer 10, acquires information on a status of the printer 10, and displays the information on the display device 21 if necessary. The information on a status of the printer 10 acquired by the status monitoring unit 42 can include states of expendables, an error occurrence situation, a print job reception situation, and the like.

In this embodiment, when the status monitor program is installed in the computer 30, as indicated by a display screen 520 shown in FIG. 6, an icon 530 corresponding to the status monitoring unit 42 is displayed in an active program display area 521 provided by the operating system unit 40 (e.g., in a task tray of a task bar in Windows (registered trademark) of Microsoft corporation).

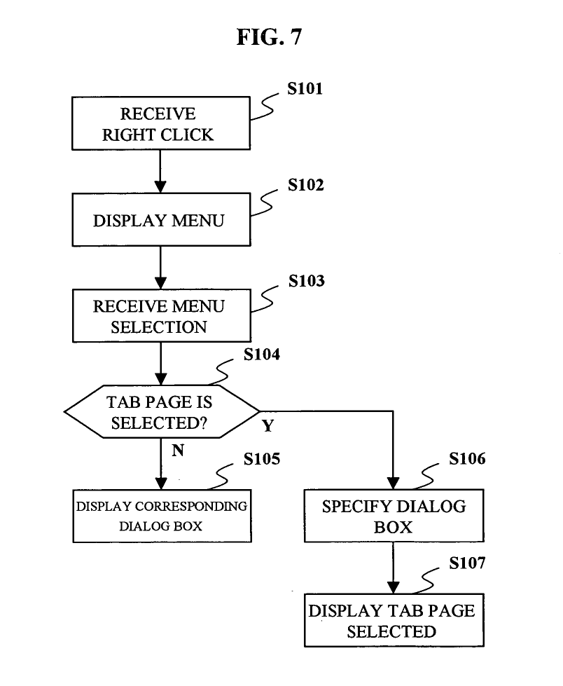

Processing in the case in which the icon 530 corresponding to the status monitoring unit 42 receives predetermined operation, for example, right click of a mouse serving as the input device 22 from a user will be explained with reference to a flow diagram in FIG. 7.

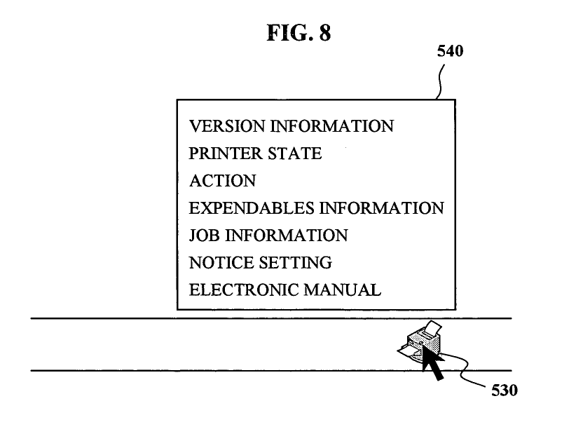

When the icon 530 corresponding to the status monitoring unit 42 receives right click (S101), the status monitoring unit 42 causes the display device 21 to display a menu 540 shown in FIG. 8 (S102).

As shown in the figure, items for causing the display device 21 to display a dialog box are displayed in a list format in a selectable state. The user can select a dialog box, which the user wishes to cause the display device 21 to display, in the menu 540.

In the menu 540, “action”, “expendables”, and “job information”, which are displayed on a tab page included in an identical dialog box, are included in a menu list as items independent from one another.

When the status monitoring unit 42 receives selection of an item in the menu 540 from the user (S103), the status monitoring unit 42 judges whether the item selected is an item displayed on the tab page (S104). In the case of this example, the status monitoring unit 42 judges which of “action”, “expendables”, and “job information” is selected.

As a result, when the selected item is not an item displayed on the tab page (S104: N), the status monitoring unit 42 displays a dialog box corresponding to the item selected in the menu (S105).

On the other hand, when the selected item is displayed on the tab page (S104: Y), the status monitoring unit 42 specifies a dialog box including the tab page (S105).

Then, the status monitoring unit 42 displays the dialog box specified. In this case, the status monitoring unit 42 displays the dialog box in a state in which the selected tab page is opened (S106). This makes it possible to directly display a target tab page.

For example, when “expendables” is selected in the menu 540, the dialog box 500 with the tab page 500b of “expendables” opened shown in FIG. 4 is displayed on the display device 21.

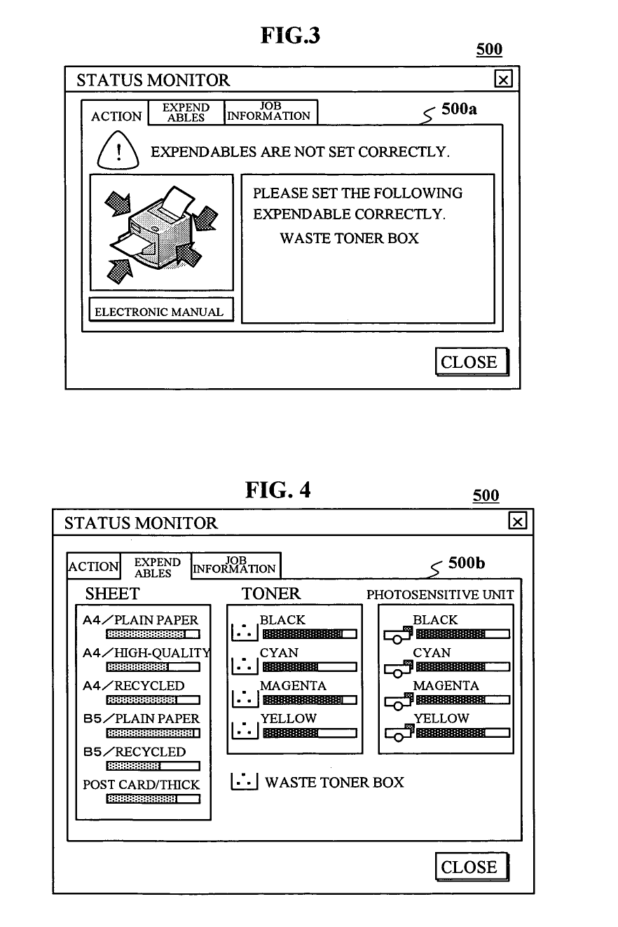

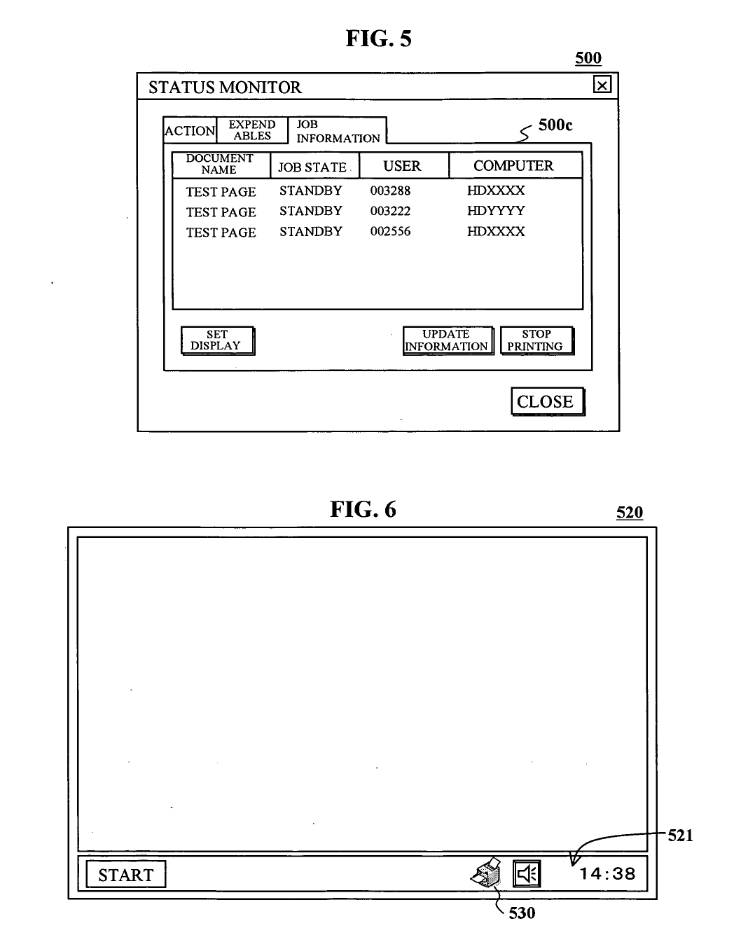

In this state, the user can switch the display to the tab page 500a of “action” shown in FIG. 3 and the tab page 500c of “job information” shown in FIG. 5 by operating a tab section of the dialog box 500. In other words, the user does not need to select items from the menu 540 again and close a tab page displayed in order to open these tab pages.

When the user wishes to cause the display device 21 to display, for example, the tab page 500a of “action” shown in FIG. 3 on another screen in a state in which the dialog box 500 with the tab page 500b of “expendables” shown in FIG. 4 opened is displayed on the display device 21, the user only has to open the menu 540 and select “action”.

As described above, according to the invention, in the graphical user interface which uses a dialog box having plural tab pages, a tab page can be directly displayed from a menu. Thus, it is possible to improve convenience of use of the graphical user interface.

What is claimed is:

1. An information processing apparatus which provides a graphical user interface via a display device, comprising:
dialog box display control means which causes the display device to display a dialog box having plural tab pages; and
menu display control means which causes the display device to display a menu for selecting items displayed as a list, wherein
the menu display control means includes items indicating the plural tab pages in the list of the menu, and
the dialog box display control means causes, when any one of the tab pages is selected in the menu, the display device to display a dialog box including the tab page in a state in which the selected tab page is displayed.

2. An information processing apparatus according to claim 1, wherein
the dialog box display control means switches, when another tab page is designated in the dialog box in which the tab page selected in the menu is displayed, the display to the designated tab page to cause the display device to display the dialog box.

3. A recording medium having recorded therein a program which is executed by an information processing apparatus including: dialog box display control means which causes a display device to display a dialog box having plural tab pages; and menu display control means which causes the display device to display a menu for selecting items displayed as a list, wherein
the program causes the information processing apparatus to perform processing for
causing the menu display control means to include a group of items indicating tab pages in a list of the menu, and
causing, when any one of the tab pages is selected in the menu, the dialog box display control means to cause the display device to display a dialog box including the tab page in a state in which the selected tab page is displayed.
